(19) United States
(12) Patent Application Publication
(10) Pub. No.: US 2025/0074830 A1
(43) Pub. Date: Mar. 6, 2025

(54) CERAMIC SUBSTRATE AND METHOD FOR MANUFACTURING THE SAME

(71) Applicant: TONG HSING ELECTRONIC INDUSTRIES, LTD., Taipei City (TW)

(72) Inventors: KAI-MOU CHOU, Taipei City (TW); SHIH-HAN WU, Taipei City (TW); JHIH-WEI LAI, Taipei City (TW); JIAN-YU SHIH, Taipei City (TW)

(21) Appl. No.: 18/386,722

(22) Filed: Nov. 3, 2023

(30) Foreign Application Priority Data
Aug. 31, 2023 (TW) 112132956

(51) Int. Cl. C04B 35/581; C04B 35/622; C04B 35/626; C04B 35/638; C04B 35/64

(52) U.S. Cl. CPC C04B 35/581; C04B 35/62218; C04B 35/6261; C04B 35/638; C04B 35/64; C04B 2235/3225; C04B 2235/386; C04B 2235/3865; C04B 2235/528; C04B 2235/5292; C04B 2235/5436; C04B 2235/5445; C04B 2235/5454; C04B 2235/6025; C04B 2235/604; C04B 2235/612; C04B 2235/6581; C04B 2235/667; C04B 2235/668; C04B 2235/78

(57) ABSTRACT

A ceramic substrate and a method for manufacturing the same are provided. The ceramic substrate includes a spheroidal aluminum nitride powder, a plate-shaped aluminum nitride powder, a boron nitride powder, and an yttrium oxide powder. A percentage by weight of the spheroidal aluminum nitride powder ranges between 63% and 90%. A percentage by weight of the plate-shaped aluminum nitride powder ranges between 0.05% and 30%. A percentage by weight of the boron nitride powder ranges between 0.05% and 2%. A percentage by weight of the yttrium oxide powder ranges between 0.05% and 5%. The method includes a tape casting operation and a primary and pressureless sintering process.

### CROSS-REFERENCE TO RELATED PATENT APPLICATION

This application claims the benefit of priority to Taiwan Patent Application No. 112132956, filed on Aug. 31, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a ceramic substrate and a method for manufacturing the same, and more particularly to a ceramic substrate that contains aluminum nitride and a method for manufacturing the same.

### BACKGROUND OF THE DISCLOSURE

During a manufacturing process, a ceramic substrate needs to pass a reliability test and a thermal cycling test. However, the structural toughness and thermal conductivity of existing ceramic substrates made of powdery aluminum nitride still do not meet practical requirements.

Therefore, how to enhance the structural toughness and the thermal conductivity of the ceramic substrate through improvements in structural design has become one of the important issues to be solved in the related art.

### SUMMARY OF THE DISCLOSURE

In response to the above-referenced technical inadequacies, the present disclosure provides a method for manufacturing a ceramic substrate, so as to enhance structural toughness and thermal conductivity of the ceramic substrate.

In order to solve the above-mentioned problems, one of the technical aspects adopted by the present disclosure is to provide a method for manufacturing a ceramic substrate. The method includes processes of: providing raw materials, in which the raw materials include a ceramic raw material powder, an organic solvent, and an adhesive, and the ceramic raw material powder includes a spheroidal aluminum nitride powder, a plate-shaped aluminum nitride powder, a boron nitride powder, and an yttrium oxide powder; comminuting and mixing the raw materials to form a slurry; stirring and deaerating the slurry; forming the slurry into a plurality of thin sheets by a tape casting operation; slicing the thin sheets to form a plurality of ceramic green sheets that fit a predetermined size; and sintering the ceramic green sheets to form the ceramic substrate.

In order to solve the above-mentioned problems, another one of the technical aspects adopted by the present disclosure is to provide a ceramic substrate, which includes: a spheroidal aluminum nitride powder, a plate-shaped aluminum nitride powder, a boron nitride powder, and an yttrium oxide powder. A percentage by weight of the spheroidal aluminum nitride powder ranges between 63% and 90%. A percentage by weight of the plate-shaped aluminum nitride powder ranges between 0.05% and 30%. A percentage by weight of the boron nitride powder ranges between 0.05% and 2%. A percentage by weight of the yttrium oxide powder ranges between 0.05% and 5%.

Therefore, in the ceramic substrate and the method for manufacturing the same provided by the present disclosure, the structural toughness of the ceramic substrate can be enhanced in strength by adding the plate-shaped aluminum nitride powder and the boron nitride powder, and improvement of the thermal conductivity can be achieved by adding the boron nitride powder and the yttrium oxide powder that have high thermal conductivities.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing a ceramic substrate according to the present disclosure; and

FIG. 2 is a schematic view showing a structure of the ceramic substrate according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

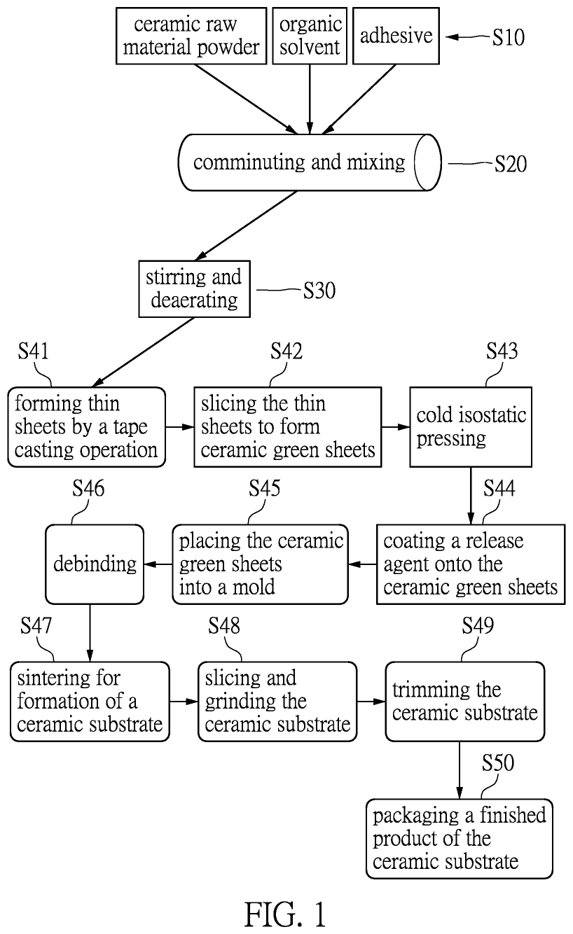

Referring to FIG. 1, the present disclosure provides a method for manufacturing a ceramic substrate, which includes the following processes. Step S10 is to provide raw materials. The raw materials include a ceramic raw material powder, an organic solvent, and an adhesive. The ceramic raw material powder (otherwise referred to as a ceramic substrate powder) includes a spheroidal aluminum nitride powder, a plate-shaped aluminum nitride powder, a boron nitride (BN) powder, and an yttrium oxide (Y₂O₃) powder.

In the ceramic raw material powder, a percentage by weight of the spheroidal aluminum nitride powder ranges between 63% and 90%, a percentage by weight of the plate-shaped aluminum nitride powder ranges between 0.05% and 30%, a percentage by weight of the boron nitride powder ranges between 0.05% and 2%, and a percentage by weight of the yttrium oxide powder ranges between 0.05% and 5%.

The plate-shaped aluminum nitride powder (i.e., a non-spherical aluminum nitride powder) is added in the ceramic substrate of the present embodiment. Due to an elongated structure of the plate-shaped aluminum nitride powder, toughness of the ceramic substrate can be enhanced. The plate-shaped aluminum nitride powder of the present embodiment can be produced by carbothermic reduction, and a synthesized powder produced in this manner has advantages of high purity, stable performance, and a small and uniform particle size. During the carbothermic reduction process, a reduction and nitridation reaction of a mixed powder of the plate-shaped aluminum nitride powder and a carbon powder is carried out in flowing nitrogen at a high temperature (approximately from 1,400° C. to 1,800° C.). Then, decarbonization is performed to generate the aluminum nitride powder.

In the present embodiment, an average thickness of the plate-shaped aluminum nitride powder ranges between 0.05 μm and 1.8 μm, an average particle size of the plate-shaped aluminum nitride powder ranges between 2 μm and 20 μm, and the average particle size is at least three times greater than the average thickness. In other words, a length of the plate-shaped aluminum nitride powder is at least three times greater than a thickness of the plate-shaped aluminum nitride powder. However, the present disclosure is not limited thereto. For example, the average particle size of the plate-shaped aluminum nitride powder can be 2 μm, 5 μm, and 7 μm. When the average particle size is 2 μm, the average thickness is 0.08 μm, and an aspect ratio is 25. When the average particle size is 5 μm, the average thickness is 0.07 μm, and the aspect ratio is approximately 70. When the average particle size is 7 μm, the average thickness is 0.1 μm, and the aspect ratio is 70.

Moreover, the boron nitride powder and the yttrium oxide powder are further added in the ceramic substrate of the present embodiment. The boron nitride powder is heat-resistant and has a high thermal conductivity. The yttrium oxide powder has a cubic structure and a high melting point. A thermal conductivity of the yttrium oxide powder is high, which is approximately 13.6 W/(m·K). Accordingly, the ceramic substrate of the present embodiment can have enhanced toughness (which is greater than 4 MPa·m\hat{ }0.5) and enhanced thermal conductivity (which is greater than 150 W/(m·K)).

Step S20 is a comminuting and mixing process, in which the raw materials are comminuted and mixed to form a slurry. For example, a ceramic powder that has been finely ground and calcined is added into the organic solvent. If necessary, an anti-coagulant, an anti-foaming agent, a sintering aid, and the like can be added before wet mulling. Then, the adhesive is added. If necessary, a plasticizer, a lubricant, and the like can be added during the mulling operation, such that the formed slurry is stable and has good fluidity.

Step S30 is to stir and deaerate the slurry. The stirring and deaerating process includes stirring the slurry for about thirty minutes in a space having a pressure less than an atmospheric pressure (which is preferably a near vacuum environment, e.g., 4,000 Pa), so as to remove gas from the slurry. Here, Pa is equivalent to N/m².

Step S41 is to form the slurry into a plurality of thin sheets by a tape casting operation. Specifically, the tape casting operation (otherwise referred to as stretch forming) includes filtering the slurry to remove the undissolved adhesive and powders that are aggregated or have large particles; coating the slurry onto a carrier by a doctor blade; and drying and curing the sheet-like slurry for formation of the thin sheets. By adopting the doctor blade, the above-mentioned tape casting operation has advantages of reduced manufacturing costs, a high production speed, a high level of automation, and a uniform structure.

Step S42 is to slice the thin sheets for formation of a plurality of ceramic green sheets that fit a predetermined size. In other words, strips of the thin sheets need to be processed (e.g., die-cutting and laminating) according to the size and shape of a finished product, so as to be manufactured into a semi-finished product that is yet to be sintered.

Step S43 is to further perform cold isostatic pressing (CIP) on the ceramic green sheets. The cold isostatic pressing is mainly adopted for formation of a powdery material at a room temperature, with rubber or a plastic material usually being used as a sleeve mold material and a liquid being used as a pressure medium. By sealing the ceramic green sheets in a forming mold that has a low deformation resistance and applying equal pressure to each surface of the forming mold, a density of a product can be increased, and the desired shape can be obtained. The used pressure generally ranges between 1,000 psi and 30,000 psi. The cold isostatic pressing allows the structure of the ceramic green sheets to be more compact.

Step S44 is a release agent coating process, in which a release agent is further coated onto the ceramic green sheets after formation of the ceramic green sheets. This process is beneficial for separating the ceramic green sheets afterwards.

Step S45 is to place the ceramic green sheets into a mold. This mold allows the ceramic green sheets to be sintered in batches, and can be made of graphite or boron nitride for withstanding a subsequent sintering temperature.

Step S46 is a debinding process for removal of organic compounds inside the ceramic green sheets. In the debinding process, the organic compounds inside the formed ceramic green sheets are removed by heating and other physical approaches. In the present embodiment, the debinding process can include thermal debinding. Specifically, the ceramic green sheets are disposed in a debinding furnace, and undergo the debinding process at a temperature of 600° C. for ten hours. A small amount of sinters may be generated during the thermal debinding process. However, the present disclosure is not limited thereto. For example, the debinding process can also include microwave-assisted debinding or organic solvent debinding.

Step S47 is to sinter the ceramic green sheets for formation of the ceramic substrate. Specifically, in the present embodiment, the sintering is carried out in nitrogen at a temperature ranging between 1,700° C. and 1,900° C. The sintering time can be adjusted according to a thickness of the ceramic green sheets. Since pressure-assisted sintering under the mold is not required in the present embodiment, and the finished product can be obtained through primary sintering, the costs can be reduced. In comparison, a yield of each steel-making cycle in a conventional hot pressing process is small, and the costs are high.

After the sintering process, step S48 is to further slice and grind the ceramic substrate according to a predetermined size and a predetermined thickness. Step S49 is to trim the ceramic substrate. Finally, step S50 is to package the finished product of the ceramic substrate.

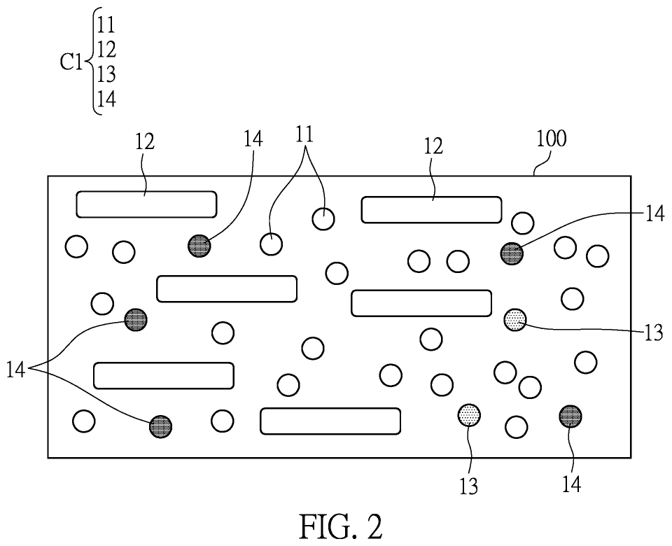

FIG. 2 shows a ceramic substrate 100 of the present embodiment after formation, in which a ceramic raw material powder C1 of the raw materials includes: a spheroidal aluminum nitride powder 11, a plate-shaped aluminum nitride powder 12, a boron nitride powder 13 in a small amount, and an yttrium oxide powder 14 in a small amount. A percentage by weight of the spheroidal aluminum nitride powder 11 ranges between 63% and 90%, and can be 66% in a practical embodiment. A percentage by weight of the plate-shaped aluminum nitride powder 12 ranges between 0.05% and 30%, and can be 30% in a practical embodiment. A percentage by weight of the boron nitride powder 13 ranges between 0.05% and 2%, and can be 0.5% in a practical embodiment. A percentage by weight of the yttrium oxide powder 14 ranges between 0.05% and 5%, and can be 3.5% in a practical embodiment. In the present disclosure, the structural toughness of the ceramic substrate can be enhanced in strength mainly by adding the plate-shaped aluminum nitride powder and the boron nitride powder, and improvement of the thermal conductivity can be achieved by adding the boron nitride powder and the yttrium oxide powder that have high thermal conductivities. In the present disclosure, since the boron nitride powder does not need to be added in a large amount, cost reduction can be achieved (which is beneficial for commercialization). However, the present disclosure is not limited thereto. The percentage by weight of the spheroidal aluminum nitride powder can be increased to 90%, so as to decrease the percentage by weight of the plate-shaped aluminum nitride powder.

### Beneficial Effects of the Embodiment

In conclusion, in the ceramic substrate and the method for manufacturing the same provided by the present disclosure, the structural toughness of the ceramic substrate can be enhanced in strength by adding the plate-shaped aluminum nitride powder and the boron nitride powder, and improvement of the thermal conductivity can be achieved by adding the boron nitride powder and the yttrium oxide powder that have high thermal conductivities.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a ceramic substrate, comprising processes of:
providing raw materials, wherein the raw materials include a ceramic raw material powder, an organic solvent, and an adhesive; wherein the ceramic raw material powder includes a spheroidal aluminum nitride powder, a plate-shaped aluminum nitride powder, a boron nitride powder, and an yttrium oxide powder;
comminuting and mixing the raw materials to form a slurry;
stirring and deaerating the slurry;
forming the slurry into a plurality of thin sheets by a tape casting operation;
slicing the thin sheets to form a plurality of ceramic green sheets that fit a predetermined size; and
sintering the ceramic green sheets to form the ceramic substrate.

2. The method according to claim 1, wherein, in the ceramic raw material powder, a percentage by weight of the spheroidal aluminum nitride powder ranges between 63% and 90%, a percentage by weight of the plate-shaped aluminum nitride powder ranges between 0.05% and 30%, a percentage by weight of the boron nitride powder ranges between 0.05% and 2%, and a percentage by weight of the yttrium oxide powder ranges between 0.05% and 5%.

3. The method according to claim 1, wherein the stirring and deaerating process includes removing gas from the slurry in a space having a pressure less than an atmospheric pressure.

4. The method according to claim 1, wherein the tape casting operation includes filtering the slurry, coating the slurry onto a base tape by a doctor blade, and drying and curing the sheet-like slurry for formation of the thin sheets.

5. The method according to claim 1, wherein, after formation of the ceramic green sheets, cold isostatic pressing is performed on the ceramic green sheets, a release agent is coated onto the ceramic green sheets, and then the ceramic green sheets are placed into a mold for a debinding process, so as to remove organic compounds inside the ceramic green sheets.

6. The method according to claim 5, wherein the debinding process includes thermal debinding or microwave-assisted debinding.

7. The method according to claim 1, further comprising processes of:
slicing and grinding the ceramic substrate according to a predetermined size and a predetermined thickness; and
trimming the ceramic substrate.

8. A ceramic substrate, comprising:
a spheroidal aluminum nitride powder, wherein a percentage by weight of the spheroidal aluminum nitride powder ranges between 63% and 90%;
a plate-shaped aluminum nitride powder, wherein a percentage by weight of the plate-shaped aluminum nitride powder ranges between 0.05% and 30%;
a boron nitride powder, wherein a percentage by weight of the boron nitride powder ranges between 0.05% and 2%; and
an yttrium oxide powder, wherein a percentage by weight of the yttrium oxide powder ranges between 0.05% and 5%.

9. The ceramic substrate according to claim 8, wherein an average thickness of the plate-shaped aluminum nitride powder ranges between 0.05 μm and 1.8 μm, an average particle size of the plate-shaped aluminum nitride powder ranges between 2 μm and 20 μm, and the average particle size is at least three times greater than the average thickness.
